(19) United States
(12) Patent Application Publication
(10) Pub. No.: US 2006/0051587 A1
(43) Pub. Date: Mar. 9, 2006

(54) Thermosetting resin composition and adhesive film

(76) Inventors: Toshiki Mori, Ibaraki (JP); Toru Fujiki, Ibaraki (JP)

Correspondence Address: BIRCH STEWART KOLASCH & BIRCH, PO BOX 747, FALLS CHURCH, VA, 22040-0747, US

(21) Appl. No.: 10/522,543

(22) PCT Filed: Jul. 18, 2003
(86) PCT No.: PCT/JP03/09149

§ 371 Date: Jan. 27, 2005

(30) Foreign Application Priority Data
Jul. 29, 2002 (JP) 2002-219298
Aug. 30, 2002 (JP) 2002-253218

(51) Int. Cl. B32B 27/38; C09J 163/00; C08L 63/00; C08F 283/00

(52) U.S. Cl. 428/413; 156/330; 525/523; 523/400

(57) ABSTRACT

The invention provides a thermosetting resin composition comprising components (A) and (B), wherein the sum of components (A) and (B) is 90% by weight or more based on the composition; an adhesive film obtained from the composition; and a laminate obtained by laminating the film and an adherent and thermally curing the resultant. Component (A) is an amino acid or imidazoles, and component (B) is an epoxy group-containing ethylene copolymer obtained by polymerizing (b₁) and (b₂), wherein (b₁) is ethylene or propylene, and (b₂) is a monomer represented by formula (1): 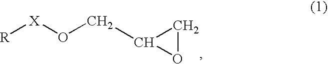 wherein R represents a hydrocarbon group of a carbon number of 2-18 having a double bond, wherein at least one of hydrogen atoms of the hydrocarbon group may be substituted with a halogen atom, a hydroxyl group or a carboxyl group, and X represents a single bond or a carbonyl group).

### FIELD OF THE INVENTION

The present invention relate to a thermosetting resin composition comprising an amino acid or imidazoles, and an epoxy group-containing ethylene-based copolymer; an adhesive film obtained from the composition; and a laminate obtained by laminating the adhesive film with an adherent and then thermally curing the resultant.

### BACKGROUND ART

In recent years, in the field of electric and electronic parts, thinning and down-sizing are being progressed, semiconductor encapsulating materials, electronic part encapsulating materials for solar cells and EL (electroluminescence) lamps, die bonding sheets between integrated circuit/substrate, and adhesives for electric and electronic part such as an interlayer insulating layer between substrates require low elastic modulus and a thinner film in addition to heat resistance to solder (hereinafter, referred to as solder heat resistance). In order to simplify a procedure of manufacturing electric and electronic parts, dry film-shaped form is required as a form before curing of an adhesive.

On the other hand, JP-A No. 2001-240838 discloses that a dry film-shaped adhesive (adhesive film) is obtained by dissolving a resin composition of an epoxy resin, an epoxy curing agent, an epoxy group-containing ethylene copolymer and imidazoles in an organic solvent, then coating the solution and drying the solvent.

### DISCLOSURE OF THE INVENTION

An object of the present invention is to provide a thermosetting resin composition which can be directly molded in a dry film-shape without steps of dissolution in an organic solvent, coating and drying; an adhesive film obtained by extrusion-molding the composition; and a laminate excellent in adhesive property and solder heat resistance which is obtained by bonding the adhesive film obtained and an adherent such as electric and electronic parts.

That is, the present invention relates to the following:

<1> A thermosetting resin composition comprising component (A) and component (B) below, wherein the sum of the content of the component (A) and component (B) is 90% by weight or more based on the composition;

component (A): at least one selected from amino acids and imidazoles, and component (B): an epoxy group-containing ethylene copolymer obtained by polymerizing monomer (b₁) and monomer (b₂) below:

monomer (b₁): at least one selected from ethylene and propylene, and

monomer (b₂): a monomer represented by formula (1) below:

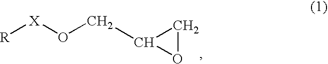

(wherein R represents a hydrocarbon group of a carbon number of from 2 to 18 having a double bond, at least one of hydrogen atoms of the hydrocarbon group may be substituted with a halogen atom, a hydroxyl group or a carboxyl group, and X represents a single bond or a carbonyl group.)

<2> The thermosetting resin composition according to the above <1>, wherein the content of a structural unit derived from monomer (b₂) is 1 to 30 parts by weight relative to 100 parts by weight of component (B).

<3> The thermosetting resin composition according to the above <1> or <2>, wherein the content of a structural unit derived from monomer (b₁) is 30 to 75 parts by weight relative to 100 parts by weight of component (B).

<4> The thermosetting resin composition according to any one of the above <1> to <3>, wherein component (B) is a copolymer obtained by polymerizing monomer (b₁), monomer (b₂) and monomer (b₃) below:

monomer (b₃): a monomer which has a functional group copolymerizable with ethylene, does not have a functional group reactive with an epoxy group, and is different from either of monomer (b₁) and monomer (b₂).

<5> The thermosetting resin composition according to any one of the above <1> to <4>, wherein the ratio by weight of component (A) and component (B) ((A)/(B)) is from 0.1/99.9 to 10/90.

<6> The thermosetting resin composition according to any one of the above <1>to <5>, which further contains component (C) below:

component (C): an antioxidant.

<7> The thermosetting resin composition according to <6>, wherein component (C) is at least one selected from the group consisting of a phenolic antioxidant, a phosphoric antioxidant and a sulfuric antioxidant.

<8> The thermosetting resin composition according to any one of the above <1> to <7>, wherein component (A) is an amino acid, and the amino acid is at least one selected from aminoacetic acid, β-alanine, 4-aminobutyric acid, aminovalerianic acid, 6-aminohexanoic acid, 11-aminoundecanoic acid and 12-aminododecanoic acid.

<9> The thermosetting resin composition according to any one of the above <1> to <7>, wherein component (A) is an imidazole, and the imidazole is at least one selected from 1-cyanoethyl-2-ethyl-4-methylimidazolium trimellitate, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-(2′-undecylimidazolyl)-ethyl-s-triazine, 2,4-diamino-6-[2′-ethyl-4-methylimidazolyl-(1′)]-ethyl-s-triazine, an adduct of 2,4-diamino-6-[2′-methylimidazolyl-(1′)]-ethyl-s-triazine with isocyanuric acid, an adduct of 2-phenylimidazole with isocyanuric acid, and an adduct of 2-methylimidazole with isocyanuric acid.

<10> An adhesive film comprising the thermosetting resin composition according to any one of the above <1> to <9>.

<11> The adhesive film according to the above <10>, which is obtained by extrusion-molding the thermosetting resin composition according to any one of the above <1> to <9>.

<12> An adhesive film, which is obtainable by further irradiating an electron beam on the adhesive film according to the above <10> or <11>.

<13> The adhesive film according to the above <12>, which is obtainable by performing the electron beam irradiation plural times.

<14> A laminate, which is obtainable by laminating the adhesive film according to any one of the above <10> to <13>with an adherent, and thermally curing the resultant.

### BEST MODE FOR CARRYING OUT THE INVENTION

The thermosetting resin composition of the present invention (hereinafter, referred to as the present composition) is characterized in that it contains the aforementioned component (A) and component (B), and the sum of the content of component (A) and component (B) is 90% by weight or more based on the composition.

Component (A) used in the present invention is at least one selected from amino acids and imidazoles.

Herein, the amino acid is a compound having an amino group and a carboxyl group, and its specific example includes aminoacetic acid, D-alanine, L-alanine, DL-alanine, β-alanine, L-2-aminoadipic acid, L-α-aminoadipic acid, o-aminobenzoic acid, m-aminobenzoic acid, p-aminobenzoic acid, D-(−)-2-aminobutyric acid, DL-2-aminobutyric acid, L-(+)-2-aminobutyric acid, 4-aminobutyric acid, 2-aminoisobutyric acid, DL-3-aminoisobutyric acid, aminovalerianic acid, DL-α-aminocaprylic acid, ω-aminocaprylic acid, 1-aminocyclobutane carboxylic acid, 1-amino-1-cyclohexane carboxylic acid, 2-amino-1-cyclohexane carboxylic acid, 2-amino-4-cyclohexene-1-carboxylic acid, 1-amino-i-cyclopentane carboxylic acid, 2-amino-i-cyclopentane carboxylic acid, 1-amino-1-cyclopropane carboxylic acid, DL-2-aminohexanoic acid, 6-aminohexanoic acid, DL-1-aminoindane-1-carboxylic acid, 2-aminoisobutyric acid, 5-aminoisophtalic acid, 2-amino-3-methylbenzoic acid, 2-amino-4-methylbenzoic acid, 2-amino-5-methylbenzoic acid, 2-amino-6-methylbenzoic acid, 4-amino-3-methylbenzoic acid, 2-amino-2-methylbutanedionic acid, 2-amino-2-methylbutanoic acid, 2-amino-4-methylpentanedionic acid, 3-amino-4-methylpetanoic acid, 2-amino-2-methyl-3-phenylpropanoic acid, 2-aminopentanoic acid, p-aminophenylacetic acid, a-aminophenylacetic acid, 2-amino-4-phenylbutyric acid, 3-amino-3-phenylpropionic acid, 11-aminoundecanic acid, 12-aminododecanoic acid and the like.

Among these, it is preferred to use at least one selected from aminoacetic acid, β-alanine,4-aminobutyric acid, aminovalerianic acid, 6-aminohexanoic acid, 11-aminoundecanoic acid and 12-aminododecanoic acid, and in particular, it is more preferred to use 12-aminododecanoic acid.

As the amino acid, commercially available amino acids such as “K-37Y” (12-aminododecanoic acid, manufactured by P.T.I. Japan Co., Ltd.) may be used as they are.

The imidazoles as component (A) is a compound having an imidazole skeleton, and their specific examples include 2-methylimidazole, 2-undecylimidazole, 2-heptadecylimidazole, 1,2-dimethylimidazole, 2-ethyl-4-methylimidazole, 2-phenylimidazole, 2-phenyl-4-methylimidazole, 1-benzyl-2-phenylimidazole, 1-benzyl-2-methylimidazole, 1-cyanoethyl-2-methylimidazole, 1-cyanoethyl-2-ethylimidazole, 1-cyanoethyl-2-undecylimidazole, 1-cyanoethyl-2-phenylimidazole, 1-cyanoethyl-2-ethyl-4-methylimidazolium trimellitate, 1-cyanoethyl-2-undecylimidazolium trimellitate, 1-cyanoethyl-2-phenyl-imidazolium trimellitate, 2,4-diamino-6-[2′-methylimidazolyl-(1′)]-ethyl-s-triazine, 2,4-diamino-6-(2′-undecylimidazolyl)-ethyl-s-triazine, 2,4-diamino-6-[2′-ethyl-4-methylimidazolyl-(1′)]-ethyl-s-triazine, an adduct of 2,4-diamino-6-[2′-methylimidazolyl-(1′)]-ethyl-s-triazine with isocyanuric acid, an adduct of 2-phenylimidazole with isocyanuric acid, and an adduct of 2-methylimidazole with isocyanuric acid, 2-phenyl-4,5-dihydroxymethylimidazole, 2-phenyl-4-methyl-5-hydroxymethylimidazole, 1-cyanoethyl-2-phenyl-4,5-di(2-cyanoethoxy)methylimidazole, 2-methylimidazoline, 2-phenylimidazoline, 1-dodecyl-2-methy-3-benzylimidazolium chloride, 1-benzyl-2-phenylimidazole hydrochloride, 1-benzyl-2-phenylimidazolium trimellitate, and the like.

Further, as component (A), imidazoles which are commercially sold as trade marks such as, for example, “CUREZOLE C11Z-A” (2,4-diamino-6-(2′-undecylimidazolyl)-ethyl-s-triazine, manufactured by Shikoku Kasei Co., Ltd.) and “CUREZOLE 2PZ-OK” (an adduct of 2-phenylimidazole with isocyanuric acid, manufactured by Shikoku Kasei Co., Ltd.) may be used as they are.

Among the above-mentioned imidazoles as component (A), in particular, from the viewpoint of the thermal stability and aging stability of the resulting thermosetting resin composition, it is preferred to use 1-cyanoethyl-2-ethyl-4-methylimidazolium trimellitate, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-(2′-undecylimidazolyl)-ethyl-s-triazine, 2,4-diamino-6-[2′-ethyl-4-methylimidazolyl-(1′)]-ethyl-s-triazine, an adduct of 2,4-diamino-6-[2′-methylimidazolyl-(1′)]-ethyl-s-triazine with isocyanuric acid, an adduct of 2-phenylimidazole with isocyanuric acid, an adduct of 2-methylimidazole with isocyanuric acid and the like.

Component (B) used in the present invention is an epoxy group-containing ethylene copolymer obtained by polymerizing

at least one monomer (hereinafter, described as monomer (b₁)) selected from ethylene and propylene and

a monomer (hereinafter, referred to as monomer (b₂)) represented by formula (1) below: 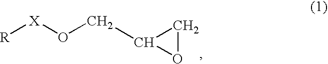
(wherein R represents a hydrocarbon group of a carbon number of from 2 to 18 having a double bond, at least one of hydrogen atoms of the hydrocarbon group may be substituted with a halogen atom, a hydroxyl group or a carboxyl group and X represents a single bond or a carbonyl group.

Inter alia, as the monomer (b₁), ethylene is preferable.

In formula (1), examples of substituent R include substituents represented by formulas (2) to (8) below:

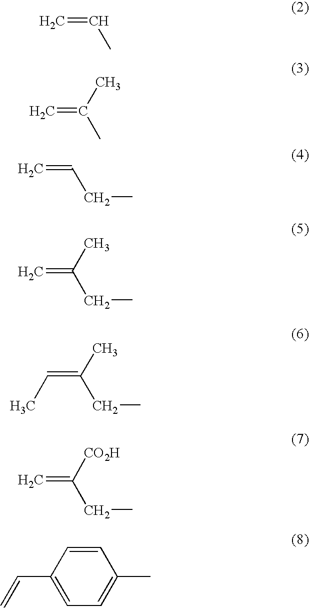

In addition, X in the formula (1) represents a single bond in which the oxygen atom and substituent R in formula (1) are directly bound with each other, or a carbonyl group.

Specific examples of monomer (b₂) include unsaturated glycidyl ether such as allylglycidyl ether, 2-methylallyglycidyl ether and styrene-p-glycidyl ether; and unsaturated glycidyl esters such as glycidyl acrylate, glycidyl methacrylate and itaconic acid glycidyl ester.

The content of structural unit derived from monomer (b₂) may be about 1 to about 30 parts by weight relative to 100 parts by weight of component (B). When the structural unit derived from monomer (b₂) is 1 part by weight or more, there is a tendency that adherability of the resulting adhesive film is improved, which is preferred. When the structural unit is 30 parts by weight or less, there is a tendency that a mechanical strength of the resulting adhesive film is improved, which is also preferred.

In addition, the content of structural unit derived from monomer (b₁) is preferably about 30 to about 99 parts by weight relative to 100 parts by weight of component (B).

For example, by polymerizing monomer (b₁) and monomer (b₂) with a monomer (hereinafter, referred to as monomer (b₃)) which is different from either of monomer (b₁) and monomer (b₂) and has a functional group copolymerizable with ethylene such as a vinyl group and an alkylene group, then component (B) may contain a structural unit derived from monomer (b₃) in addition to a structural unit derived from monomer (b₁) and a structural unit derived from monomer (b₂). It is noted that monomer (b₃) should not substantially contain a functional group (which can react with an epoxy group) such as a carboxyl group (—COOH) and an acid anhydride group (—CO—O—CO—), but may contain an ester group since the ester group does not react with an epoxy group.

Specific examples of monomer (b₃) include an α,β-unsaturated carboxylic acid alkyl ester having an alkyl group of a carbon number of about 3 to about 8 (such as methyl acrylate, ethyl acrylate, n-propyl acrylate, isopropyl acrylate, n-butyl acrylate, t-butyl acrylate, isobutyl acrylate, methyl methacrylate, ethyl methacrylate, n-propyl methacrylate, isopropyl methacrylate, n-butyl methacrylate, t-butyl methacrylate and isobutyl methacrylate); a vinyl ester with a carboxylic acid of a carbon number of about 2 to about 8 (such as vinyl acetate, vinyl butyrate, vinyl propionate, vinyl pivalate, vinyl laurate, vinyl isononanate and vinyl versatate); an α-olefins of a carbon number of about 4 to about 20 (such as 1-butene and isobutene); a diene compound of a carbon number of about 3 to about 20 (such as butadiene, isoprene and cyclopentadiene); a vinyl compound of a carbon umber of about 2 to about 20 (such as vinyl chloride, styrene, acrylonitrile, methacrylonitrile, acrylamide and methacrylamide).

As monomer (b₃), inter alia, vinyl acetate, methyl acrylate, ethyl acrylate, n-butyl acrylate and methyl methacrylate are preferred.

The content of structural unit derived from monomer (b₃) may be about 0 to about 70 parts by weight, and is preferably about 5 to about 60 parts by weight, relative to 100 parts by weight of component (B). When the content is 70 parts by weight or smaller, there is a tendency that component (B) can be easily prepared by a high pressure radical method, which is preferred.

Component (B) may be any of a block copolymer, a graft copolymer, a random copolymer and an alternating copolymer. Examples thereof include a copolymer obtained by grafting monomer (b₂) onto a propylene-ethylene block copolymer described in Japanese Patent No.2632980 (corresponding to U.S. Pat. No. 5,032,459) and a copolymer obtained by grafting α,β-unsaturated carboxylic acid ester onto a copolymer (described in Japanese Patent No.2600248) of ethylene and an epoxy group-containing monomer.

Examples of a process for preparing component (B) in the present invention include:

a method of copolymerizing a monomer as a raw material under a pressure of from about 500 to about 4000 atm at a temperature of from about 100 to about 300° C. in the presence of ethylene and a radical generator, and also in the presence or the absence of a proper solvent or a chain transfer agent; and

a method of mixing a monomer such as monomer (b₂) as a raw material and a radical generator with a polyethylene resin and then melt-graft-copolymerizing the resulting mixture in an extruder.

Herein, the polyethylene resin may be a homopolymer of monomer (b₁), or a copolymer of monomer (b₃) and monomer (b₁), or the like.

Component (B) in the present invention preferably has a MFR (melt flow rate; measured in accordance with JIS K7210) of from about 30 g to about 1000 g per 10 minutes, and more preferably has a MFR of from about 50 g to about 500g per 10 minutes, under the conditions of 2.16 kg load at a temperature of 190° C. When the MFR is 30 g/10 minutes or larger, there is a tendency that flowability of the resulting thermosetting resin composition is improved so that, even when there are irregularities on a surface of an adherent, they are easily embedded, which is preferred. On the other hand, when the MFR is 1000 g/10 minutes or smaller, there is a tendency that solder heat resistance of the resulting thermosetting resin composition is improved, which is also preferred.

Component (B) may be commercially available one, and examples thereof include “Bondfast (registered trade mark)” series (manufactured by Sumitomo Chemical Co., Ltd.), “Sepolsion G (registered trademark)” series (manufactured by Sumitomo Seika Chemicals Co., Ltd.) and “Rexpearl RA (registered trade mark)” series (manufactured by Nippon Polyolefin K.K.).

The present composition can be obtained by mixing component (A) and component (B), and component (A) and component (B) may be compatible with each other in the present composition. Further, the sum of the content of component (A) and component (B) is 90% by weight or more, preferably 95% by weight or more and more preferably 99% by weight or more, based on the present composition.

The ratio by weight of component (A) to component (B) ((A)/(B)) may be from 0.1/99.9to about 10/90, and is preferably from 0.5/99.5 to 6/94.

In addition, the present composition may contain a promoter for curing an epoxy resin, such as an organic phosphorus compound, in addition to component (A) and component (B) in order to promote a curing reaction of the component (A) and component (B).

By inclusion of an antioxidant as component (C) in addition to component (A) and component (B) in the present composition, there is a tendency that, when the composition is molded into a film, occurrence of un-uniform foreign matter called “fish eye” is suppressed, and storage stability of the composition and the resulting adhesive film obtained from the composition is improved. Therefore, component (C) is preferably contained.

Examples of component (C) include a phenolic antioxidant, a phosphoric antioxidant, a sulfuric antioxidant, and an amine antioxidant. As the antioxidant, two or more kinds of antioxidants may be used by combining them. Inter alia, from a viewpoint of gel-preventing effect and coloring, it is preferred to use any of a phenolic antioxidant, a phosphoric antioxidant and a sulfuric antioxidant.

Examples of the phenolic antioxidant include 2,6-di-t-butyl-4-methylphenol, 2,6-di-t-butyl-4-ethylphenol, 2,6-dicyclohexyl-4-methylphenol, 2,6-di-t-amyl-4-methylphenol, 2,6-di-t-octyl-4-n-propylphenol, 2,6-dicyclohexyl-4-n-octylphenol, 2-isopropyl-4-methyl-6-t-butylphenol, 2-t-butyl-2-ethyl-6-t-octylphenol, 2-isobutyl-4-ethyl-6-t-hexylphenol, 2-cyclohexyl-4-n-butyl-6-isopropylphenol, dl-α-tocopherol, t-butylhydroquinone, 2,2′-methylenebis(4-methyl-6-t-butylphenol), 4,4′-butylidenebis(3-methyl-6-t-butylphenol), 4,4′-thiobis(3-methyl-6-t-butylphenol), 2,2′-thiobis(4-methyl-6-t-butylphenol), 4,4′-methylenebis(2,6-di-t-butylphenol), 2,2′-methylenebis[6-(1-methylcyclohexyl)-p-cresol], 2,2′-ethylidenebis(4,6-di-t-butylphenol), 2,2′-butylidenebis(2-t-butyl-4-methylphenol), 2-t-butyl-6-(3-t-butyl-2-hydroxy-5-methylbenzyl)-4-methyl-phenyl acrylate, 2-[1-(2-hydroxy-3,5-di-t-pentylphenyl)ethyl)-4,6-di-t-pentylphenylacrylate, 1,1,3-tris(2-methyl-4-hydroxy-5-t-butylphenyl)butane, triethylene glycol bis[3-(3-t-butyl-5-methyl-4-hydroxyphenyl)propionate], 1,6-hexanediol bis[3-(3,5-di-t-butyl-4-hydroxyphenyl)propionate], 2,2-thiodiethylenebis[3-(3,5-di-t-butyl-4-hydroxyphenyl)-propionate], N,N′-hexamethylenebis(3,5-di-t-butyl-4-hydroxy-hydrocinnamide), 3,5-di-t-butyl-4-hydroxybenzylphosphonate diethyl ester, tris(2,6-dimethyl-3-hydroxy-4-t-butylbenzyl) isocyanurate, tris(3,5-di-t-butyl-4-hydroxybenzyl) isocyanurate, tris[(3,5-di-t-butyl-4-hydroxyphenyl)propionyloxyethyl]isocyanurate, tris(4-t-butyl-2,6-dimethyl-3-hydroxybenzyl)isocyanurate, 2,4-bis(n-octylthio)-6-(4-hydroxy-3,5-di-t-butylanilino)-1,3,5-triazine, tetrakis[methylene-3-(3,5-di-t-butyl-4-hydroxyphenyl)-propionatelmethane, 2,2′-methylenebis(4-methyl-6-t-butylphenol) terephthalate, 1,3,5-trimethyl-2,4,6-tris(3,5-di-t-butyl-4-hydroxybenzyl)-benzene, 3,9-bis[1,1-dimethyl-2-(f-(3-t-butyl-4-hydroxy-5-methyl-phenyl)propionyloxy)ethyl]-2,4,8,10-tetraoxaspiro[5,5]-undecane, 2,2-bis[4-(2-(3,5-di-t-butyl-4-hydroxyhydrocinnamoyloxy))-ethoxyphenyl]propane, and β-(3,5-di-t-butyl-4-hydroxyphenyl)propionic acid stearyl ether.

Among them, β-(3,5-di-t-butyl-4-hydroxyphenyl)propionic acid stearyl ester, tetrakis[methylene-3-(3,5-di-t-butyl-4-hydroxyphenyl)-propionatelmethane, tris(3,5-di-t-butyl-4-hydroxybenzyl)isocyanurate, 1,3,5-trimethyl-2,4,6-tris(3,5-di-t-butyl-4-hydroxybenzyl)-benzene, dl-α-tocopherol, tris(2,6-dimethyl-3-hydroxy-4-t-butylbenzyl) isocyanurate, tris[(3,5-di-t-butyl-4-hydroxyphenyl)propionyloxyethyl]-isocyanurate, and 3,9-bis[1,1-dimethyl-2-{f-(3-t-butyl-4-hydroxy-5-methyl-phenyl)propionyloxy}ethyl]-2,4,8,10-tetraoxaspiro[5,5]-undecane are preferable.

As the phenolic antioxidant, commercially available phenolic antioxidants may be used, and examples of such a commercially available phenolic antioxidants include Irganox 1010 (manufactured by Ciba Specialty Chemicals), Irganox 1076 (manufactured by Chiba Specialty Chemicals), Irganox 1330 (manufactured by Chiba Specialty Chemicals), Irganox 3114 (manufactured by Chiba Specialty Chemicals), Irganox 3125 (manufactured by Chiba Specialty Chemicals), Sumilizer BHT (manufactured by Sumitomo Chemical Co., Ltd.), Cyanox 1790 (manufactured by Cytech), Sumilizer GA-80 (manufactured by Sumitomo Chemical Co., Ltd.), and vitamin E (manufactured by Esai).

As the phenolic antioxidant, two or more of phenolic antioxidants may be used.

Examples of the phosphoric antioxidant include trioctyl phosphite, trilauryl phosphite, tridecyl phosphite, (octyl)diphenyl phosphite, tris(2,4-di-t-butylphenyl) phosphite, triphenyl phosphite, tris(butoxyethyl) phosphite, tris(nonylphenyl) phosphite, distearylpentaerythritol diphosphite, tetra(tridecyl)-1,1,3-tris(2-methyl-5-t-butyl-4-hydroxy-phenyl)butane diphosphite, tetra(C₁₂˜C₁₅ mixed alkyl)-4,4′-isopropylidenediphenyl diphosphite, tetra(tridecyl)-4,4′-butylidenebis(3-methyl-6-t-butyl-phenol)diphosphite, tris(3,5-di-t-butyl-4-hydroxyphenyl) phosphite, tris(mono-, di-mixed nonylphenyl) phosphite, hydrogenated-4,4′-isopropylidenediphenol polyphosphite, bis(octylphenyl)bis[4,4′-butylidenebis(3-methyl-6-t-butyl-phenol)]-1,6-hexanediol diphosphite, phenyl(4,4′-isopropylidenediphenol)pentaerythritol diphosphite, distearylpentaerythritol diphosphite, tris[4,4′-isopropylidenebis(2-t-butylphenol)]phosphite, di(isodecyl)phenyl phosphite, 4,4′-isopropylidenebis(2-t-butylphenol)bis(nonylphenyl)phosphite, 9,10-dihydro-9-oxa-10-phosphaphenanthrene-10-oxide, bis(2,4-di-t-butyl-6-methylphenyl)ethyl phosphite, 2-[{2,4,8,10-tetra-t-butyldibenz[d,f][1.3.21-dioxaphosphepin-6-yl}oxy]-N,N-bis[2-[(2,4,8,10-tetra-t-butyldibenz[d,f][1.3.2]-dioxaphosphepine-6-yl)oxy)ethyl]ethaneamine, 6-[3-(3-t-butyl-4-hydroxy-5-methylphenyl)propoxyl-2,4,8,10-tetra-t-butyldibenz[d,f][1.3.2]-dioxaphosphepine.

In addition, other example compounds as the phosphoric antioxidant, such as bis(dialkylphenyl)pentaerythritol diphosphite ester, include a spiro-type compound represented by formula (9) below: 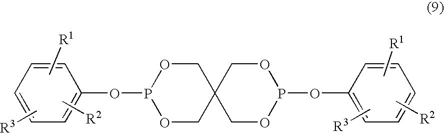
(wherein R¹, R² and R³ represent independently a hydrogen atom or an alkyl group of a carbon number of from 1 to about 9), and a cage-type compound represented by formula (10) below: 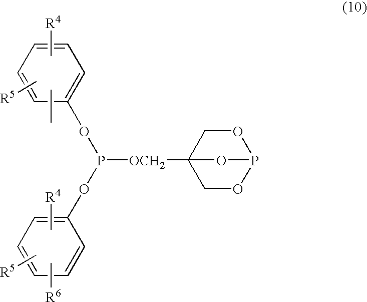
(wherein R⁴, R⁵ and R⁶ represent independently a hydrogen atom or an alkyl group of a carbon number of from 1 to about 9).

As such a phosphite ester, usually, a mixture of compounds represented by formulas (9) and (10) may be used.

When substituents R¹ to R⁶ are alkyl groups, then branched alkyl groups are preferred and, inter alia, t-butyl groups are preferred.

In addition, as a position of substituents R¹ to R⁶ in the phenyl groups, 2, 4 and 6 positions are preferred.

Specific examples of phosphite ester as a phosphoric antioxidant include bis(2,4-di-t-butylphenyl)pentaerythritol diphosphite, bis(2,6-di-t-butyl-4-methylphenyl)pentaerythritol diphosphite, bis(nonylphenyl)pentaerythritol diphosphite and the like. In addition, examples of a phosphoric antioxidant, which is a phosphonite having a structure in which carbon and phosphorus are directly bound, include a compound such as tetrakis(2,4-di-t-butylphenyl)-4,4′-biphenylenedi-phosphonite.

As the phosphoric antioxidant, commercially available phosphoric antioxidants may be used, and examples include Irgafos 168 (manufactured by Chiba Specialty Chemicals), Irgafos 12 (manufactured by Chiba Specialty Chemicals), Irgafos 38 (manufactured by Chiba Specialty Chemicals), ADK STAB 329K (manufactured by Asahi Denka Kogyo K.K.), ADK STAB PEP 36 (manufactured by Asahi Denka Kogyo K.K.), ADK STAB PEP-8 (manufactured by Asahi Denka Kogyo K.K.), Sandstab P-EPQ (manufactured by Clariant), Weston 618 (manufactured by GE), Weston 619G (manufactured by GE), Ultranox 626 (manufactured by GE), and Sumilizer GP (manufactured by Sumitomo Chemical Co., Ltd.).

As the phosphoric antioxidant, two or more kinds of phosphoric antioxidants may be used.

Among phosphoric antioxidants, tris(2,4-di-t-butylphenyl) phosphite, tetrakis(2,4-di-t-butylphenyl)-4,4′-biphenylene diphosphanite, distearylpentaerythritol diphosphite, bis(2,4-di-t-butylphenyl)pentaerythritol diphosphite, 2-[{2,4,8,10-tetra-t-butyldibenz[d,f][1.3.2]-dioxa-phosphepin-6-yl)oxy]-N,N-bis[2-[{2,4,8,10-tetra-t-butyl-dibenz[d,f][1.3.2]-dioxaphosphepine-6-yl}oxylethyl]ethaneamine, and 6-[3-(3-t-butyl-4-hydroxy-5-methylphenyl)propoxy]-2,4,8,10-tetra-t-butyldibenz[d,f][1.3.2]-dioxaphosphepine are preferable.

Examples of the sulfuric antioxidant include dialkylthiodipropionate (such as dilauryl-, dimyristyl- and distearyl-thiodipropionate); and esters of polyhydric alcohols (e.g. glycerin, trimethylolethane, trimethylolpropane, pentaerythritol, trishydroxyethyl isocyanurate) with alkylthiopropionic acid (such as butyl-, octyl-, rauryl-, and stearyl-thiopropionic acid)(e.g. pentaerythryltetrakis-3-laurylthiopropionate).

Further specific examples of the sulfuric antioxidant include dilauryl thiodipropionate, dimyristyl thiodipropionate, distearyl thiodipropionate, laurylstearyl thiodipropionate, and distearyl thiodibutyrate.

Among them, pentaerythryltetrakis-3-lauryl thiopropionate is preferable.

As the sulfuric antioxidant, commercially available sulfuric antioxidants may be used, and examples thereof include Sumilizer TPS (manufactured by Sumitomo Chemical Co., Ltd.), Sumilizer TPL-R (manufactured by Sumitomo Chemical Co., Ltd.), Sumilizer TPM (manufactured by Sumitomo Chemical Co., Ltd.), and Sumilizer TP-D (manufactured by Sumitomoe Chemical Co., Ltd.).

As the sulfuric antioxidant, two or more kinds of sulfuric antioxidants may be used.

Examples of the amine antioxidant include a polymer of 2,2,4-trimethyl-1,2-dihydroquinoline, 6-ethoxy-2,2,4-trimethyl-1,2-dihydroquinoline, N-(1,3-dimethylbutyl)-N′-phenyl-1,4-phenylenediamine, and N-isopropyl-N′-phenyl-1,4-phenylenediamine.

The amount of component (C) to be blended in the present composition may be from about 0.005 to about 2 parts by weight, preferably from about 0.01 to about 1 part by weight, more preferably from about 0.05 to about 0.5 part by weight, relative to 100 parts by weight of component (A).

The present composition contains component (A) and component (B), and examples of a process for preparing the composition include a method of melting and kneading component (A) usually at a temperature of about 120° C. to 200° C. with a 5 monoaxial or a biaxial screw extruder, a Banbury mixer, a roll or various kneaders, and then mixing component (B) therewith; a method of dry-blending component (A) and component (B), and then melting and kneading the resulting blend usually at a temperature of about 120° C. to 150° C. with a monoaxial or biaxial screw extruder, a Banbury mixer, a roll or various kneaders. Herein, when component (B) is massive, it is preferred to conduct the mixing after being converted into a powder with a grinder such as a feather mill, a Nara-type grinder and an air mill, so that the melting and kneading are simplified.

In addition, when the present composition containing the component (C) is prepared, it is preferred that component (C) and component (A) are both melted and kneaded.

Further, additives such as a phenol resin, an epoxy curing agent such as an acid anhydride, a coloring agent, an inorganic filler, a processing stabilizer, a weather resistant agent, a thermal stabilizer, an optical stabilizer, a nucleating agent, a lubricant, a releasing agent, a flame-retardant and an antistatic agent may be contained in the present composition.

When the present composition is utilized in a solder resist, in order to mask a conductive circuit on a surface of a printed circuit board, a dye and a pigment such as phthalocyanine green and carbon black are usually used as a coloring agent.

An adhesive film of the present invention (hereinafter, described as the present adhesive film) is a mode in which the present composition is molded into a thin layer shape (film shape) Example of the production method includes:

(I) a method of extrusion-molding the present composition in a film shape with a T-die extruder and the like;

(II) a method of extrusion-molding the present composition in a film shape on a supporting substrate with a T-die extruder and the like;

(III) a method of laminating the film obtained by the above method (I) on a supporting substrate; and the like.

Among these, the present adhesive film obtained by the above method (II) is preferred for the use of electric and electronic parts.

Herein, a process for preparing a film obtained by extrusion molding (e.g. the above methods (I) and (II)) will be further explained below. A distance (air gap) between a T-die and a chill roll may be about 10 cm or smaller, preferably about 8 cm or smaller, more preferably about 6 cm or smaller. When the air gap is 10 cm or smaller, there is a tendency that film breakage and variation (dispersion) of a film thickness generally called “one-side thick” are suppressed, which is preferred.

In a method by extrusion molding, the present composition is melted and kneaded, and then is extruded and molded. The melting and kneading temperature is preferably not lower than a melting temperature of a resin to be used, and not higher than about 120° C., and is more preferably from about 90° C. to about 110° C. When the melting and kneading temperature is 120° C. or lower, there is a tendency that “fish eye” of the resulting adhesive film is reduced, which is preferred.

The thickness of the present adhesive film obtained by extrusion molding may be from about 5 μm to about 2 mm, and is preferably from 8 μm to 1 mm.

Examples of the support substrate include a polyolefin film such as a film composed of a 4-methyl-1-pentene copolymer, a cellulose acetate film, a releasing paper in which a silicone releasing agent or a fluorine releasing agent is coated on the side thereof to be contacted with a layer composed of a thermosetting resin composition, and a releasing polyethylene terephthalate (PET) film.

In preparation of a laminate obtained by laminating the present adhesive film with an adherent and thermally curing the resultant, it is preferred that the present adhesive film is irradiated with an electron beam before the lamination of the present adhesive film and the adherent, or after the lamination and before the thermal curing, so that squeeze-out of the adherent due to flowing of the resin component derived form the present adhesive film at the thermal curing can be prevented. When electron beam irradiation is performed after the lamination of the adherent with the present adhesive film and before the thermal curing, heat resistance of the present adhesive film can be improved in addition to the aforementioned effect of preventing squeeze-out of the resin, which is more recommendable.

An electron beam to be used is a bundle of electrons accelerated with a voltage, and can be classified into low energy-type electron beam to be accelerated with a voltage of around 50 to 300 kV, intermediate energy-type electron beam to be accelerated with a voltage of around 300 to 5000 kV, and high energy-type electron beam to be accelerated with a voltage of around 5000 to1000 kV. When applied to the present invention, a low energy-type electron beam may be used.

Examples of an electron accelerator include a linear cathode type, a module cathode type, a thin plate cathode type, and a low energy scanning type.

Examples of a method of irradiating an electron beam include:

a method of irradiating an electron beam on only one side not covered with a support substrate in a laminate of the present adhesive film (obtained by extrusion molding) with the support substrate under inert gas atmosphere such as nitrogen;

a method of irradiating an electron beam on a side covered with the support substrate in the laminate;

a method of peeling off the support substrate from the laminate, and the irradiating an electron beam on one side or both sides of the present adhesive film; and

a method of peeling off the support substrate from the laminate, laminating in advance the resulting laminate with an adherent described below, and the irradiating an electron beam thereto.

An electron beam of a desired dose may be irradiated once. When an electron beam of around 80 kGy or larger is irradiated, it is preferred to irradiate an electron beam plural times, for example, about two times in order to maintain appearance of the adhesive film obtained after electron beam irradiation, or in order to increase a crosslinking density of the adhesive film by the electron beam irradiation.

A total irradiation dose of an electron beam may be from about 10 to about 300 kGy, and is preferably from about 50 to about 250 kGy. There is a tendency that when an irradiation dose is 10 kGy or larger, effect of opacifying a surface of an adherent upon rolling of a film at thermal adhesion and thermal curing is improved, which is preferred. There is a tendency that, when the dose is 300 kGy or smaller, the adhesive film is embedded in conformity with irregularities of an adherent so that adherability is improved, which is also preferred.

The laminate of the present invention (hereinafter, referred to as a present laminate) is a laminate such that the present adhesive film is laminated with an adherent and is thermally cured. It is preferred to irradiate in advance an electron beam on the present adhesive film before the thermal curing (which may be conducted before or after lamination on the adherent) as described above.

As the adherent, different two or more kinds of adherents may be used.

A process for preparing the present laminate will be explained below, referring to the present adhesive film on which a support substrate is laminated as an example. Examples of the process include:

a method of peeling off a support substrate from the present adhesive film, laminating an adherent on both sides or one side of the present adhesive film, and then thermally curing the resultant;

a method of laminating an adherent on a side of the present adhesive film on which a support substrate is not laminated, peeling off the support substrate from the adhesive film and, if necessary, laminating another adherent onto a side from which a support substrate has been peeled off, and then thermally curing the resultant; and

a method of laminating the present adhesive film at the side on which a support substrate is not laminated, with an adherend, thermally curing the resultant, and then finally peeling off the support substrate from the adhesive film.

Examples of thermal curing conditions for preparing the present laminate include a condition of maintaining a temperature of from about 100° C. to about 350° C., preferably from about 120° C. to about 300° C., more preferably from about 160° C. to about 200° C., for the period of time from about 10 minutes to about 3 hours. There is a tendency that, when the temperature is 100° C. or higher, a thermal curing time until good solder heat resistance is obtained is shortened, which is preferred. On the other hand, when the temperature is 350° C. or lower, thermal degradation of the present adhesive film is suppressed, which is also preferred.

In addition, upon thermal curing, pressurization may be performed at a pressure of 0 to 6 MPa using a heatable press machine.

Examples of a material for adherent which may be used in the present laminate include materials which can be adhered with the present adhesive film. Specific examples of the material include inorganic materials such as metals (for example, gold, silver, copper, iron, tin, lead, aluminum and silicon), glasses, and ceramics; and synthetic polymer materials such as cellulose polymer materials (for example, paper and cloth), melamine resins, acryl-urethane resins, urethane resins, a (meth)acryl resin, styrene-acrylonitrile copolymers, polycarbonate resins, phenol resins, alkyd resins, epoxy resins, and silicone resins.

A material for the adherent may be a mixture or a composite material composed of two or more kinds of materials. When the present laminate is such that different two adherents are adhered via the present adhesive film, the materials constituting the two adherents may be the same kind material or different kinds of materials.

A shape of the adherent is not particularly limited, and examples thereof include film-like, sheet-like, plate-like, and fiber-like forms.

In addition, if necessary, the adherent may be subjected to surface treatment such as releasing agent treatment, covering treatment such as plating, coating treatment with a paint containing a resin composition other than the present composition, surface modifying treatment with plasma or laser, surface oxidizing treatment, and etching.

As the adherent, electric or electronic parts such as an integrated circuit and a printed circuit board, which are a composite material of a synthetic polymer material and a metal, are preferably used.

The following Examples further illustrate the invention in detail, but the present invention is not limited thereto.

As components (A), (B) and (D), the following components were used. An MFR (melt flow rate) value was measured under the conditions of 2160 g load at a temperature of 190° C., in accordance with JIS-K7210.

<Component (A)>

Component A-1:

2,4-Diamino-6-(2′-undecylimidazolyl)-ethyl-s-triazine,

(“CUREZOLE C11Z-A”, manufactured by Shikoku Kasei Co., Ltd.)

Component A-2:

An adduct of 2-phenylimidazole with isocyanuric acid,

(“CUREZOLE 2PZ-OK” manufactured by Shikoku Kasei Co., Ltd.)

Component A-3:

“K-37Y”, manufactured by P.T.I. Japan Co., Ltd. (main component: 12-aminododecanoic acid)

<Component (B)>

Component B-1:

Ethylene-glycidyl methacrylate copolymer (manufactured by Sumitomo Chemical Co., Ltd.; content of a structural unit derived from glycidyl methacrylate: 18.0% by weight; MFR=350 g/10 min)

<Component (C)>

Component C-1:

β-(3,5-Di-t-butyl-4-hydroxyphenyl)propionic acid stearyl ester (Phenolic antioxidant, Irganox 1076; manufactured by Ciba Specialty Chemicals)

Component C-2:

Tris(2,4-di-t-butylphenyl) phosphite (Phosphoric antioxidant, Irgafos 168; manufactured by Ciba Specialty Chemicals)

Component C-3:

Pentaerythryltetrakis-3-lauryl tiopropionate (Sulfuric antioxidant, Sumilizer TP-D; manufactured by Sumitomo Chemical Co., Ltd.)

### EXAMPLE 1

(1) <Production Example of Thermosetting Resin Composition>

Components A-1 (1 part), B-1 (100 parts), D-1 (0.1 part), D-2 (0.1 part) and D-3 (0.05 part) were blended in dry, the resulting mixture was fed to a co-rotating biaxial extruder (L/D=42) of φ 30 mm, and was melt-kneaded at a screw rotational frequency of 180 rpm and a feed speed of 16 Kg/hr under a temperature of 120° C. to obtain a thermosetting resin composition.

(2) <Production Example of Adhesive Film>

Using an extruder with T-die having a diameter of 20 mm (Laboplasto Mill; manufactured by TOYO Seiki Co., Ltd.), the cylinder temperature of the extruder was set at 100° C., the temperature of T-die was set at 90° C. and an air gap-was set at 2 cm. The thermosetting resin composition obtained above was extruded using the above-mentioned extruder to prepare an adhesive film having a thickness of about 50 μm.

(3) <Production Example of Laminate>

Onto a printed circuit board (R-1705, a both side copper-clad laminate plate manufactured by Matsushita Electric Works, Ltd.) was used as an adherent, the adhesive film having a thickness of about 50 μm obtained in the above-mentioned item (2) was thermally clamped under the conditions of 100° C. at 3MPa for 10 minutes, and then was thermally cured under the conditions of 180° C. at 3MPa for 60 minutes to obtain a laminate. The laminate was subjected to a solder heat resistance test and a peeling strength test below.

(4) <Solder Heat Resistance Test>

The resulting laminate was immersed in a solder bath at 260° C. for 10 seconds using SOLDERABILITY TESTER EST-11 manufactured by Tabai Espec Corp. Letting this to be one cycle, 6 cycles were repeated, and appearance of the surface of the laminate was observed with naked eyes. The results are summarized in Table 1.

The result of solder heat resistance test was evaluated based on the following criteria with marks ◯ and x.

◯: No abnormality (such as peeling and dilation) was observed in appearance of the thermally cured adhesive layer, and no solder grain is observed.

x: Abnormality (such as peeling and dilation) is observed in appearance of the thermally cured adhesive layer, or solder grain is observed.

(5) <Peeling Test>

An aluminum foil, a reinforcing material (polyethylene terephthalate film having a thickness of 50 μm), the adhesive film obtained in the above-mentioned item (2), an adherent (a substrate with a copper foil; one side copper-clad laminate plate, R-1705 (FR4 printed circuit plate) manufactured by Matsushita Electric Works, Ltd.; at a side of a non-wiring pattern of the printed circuit board) and an aluminum foil were laminated in this order, and one portion (a width of 25 mm) of the resultant was bonded by being maintained at a temperature of 180° C. under a pressure of 0.5 MPa for 60 minutes from an upper portion using a heat seal tester (manufactured by Tester Sangyo Co., Ltd.). The aluminum foils of the resulting laminate were peeled off and the laminate was allowed to stand for 1 hour under the conditions of a temperature of 23° C. and a humidity of 50%. Then, the laminate was cut into a piece of 10 mm width x 100 mm length (adhesion length 25 mm) and a peeling test was performed at a peeling speed of 50 mm/sec and a peeling angle of 900 under the conditions of a temperature of 23° C. and a humidity of 50% while holding a portion not bonded. The result is shown in Table 1.

### EXAMPLE 2

A thermosetting resin composition, an adhesive film having a thickness of about 50 μm and a laminate were obtained in the same manner as in EXAMPLE 1 except that 2 parts of Component A-2 was used as component (A). The results of the solder heat resistance test and the peeling test are shown in Table 1.

### EXAMPLE 3

A thermosetting resin composition, an adhesive film having a thickness of about 50 μm and a laminate were obtained in the same manner as in EXAMPLE 1 except that one part of Component A-3 was used as component (A). The results of the solder heat resistance test and the peeling test are shown in Table 1.

### COMPARATIVE EXAMPLE 1

A thermosetting resin composition, an adhesive film having a thickness of about 50 μm and a laminate were obtained in the same manner as in EXAMPLE 1 except that only Component B-1 was used without using component (A) and component (B). The results of the solder heat resistance test and the peeling test are shown in Table 1.

TABLE 1

| | | | | | Comparative |
|---|---|---|---|---|---|
| | | Example | | | Example |
| | | 1 | 2 | 3 | 1 |
| Mixing | A-1 (Parts) | 1 | — | — | — |
| ratio | A-2 (Parts) | — | 2 | | — |
| | A-3 (Parts) | | | 1 | |
| | B-1 (Parts) | 100 | 100 | 100 | 100 |
| | C-1 (Parts) | 0.1 | 0.1 | 0.1 | — |
| | C-2 (Parts) | 0.1 | 0.1 | 0.1 | — |
| | C-3 (Parts) | 0.05 | 0.05 | 0.05 | — |
| Peeling | Resin-clad | 16.8 | 8.9 | 19.9 | 11.1 |
| test | copper foil | | | | |
| | (N/10 mm) | | | | |
| | FR4 substrate | 19.3 | 16.2 | 22.6 | 5.8 |
| | (N/10 mm) | | | | |

| | | | | |
|---|---|---|---|---|
| Solder heat resistance | ◯ | ◯ | ◯ | X |
| test | | | | |

### EXAMPLE 4

(1) <Production Example of Adhesive Film Containing Support Substrate>

A cylinder temperature of an extruder equipped with φ 40 mm T-die and having an air gap of 4 cm was set at 100° C., and a T-die temperature of the extruder was set at 90° C. Subsequently, Components A-1 (1 part), B-1 (100 parts), C-1 (0.1 part), C-2 (0.1 part) and C-3 (0.05 part) were dry-blended, were fed to a co-rotating biaxial extruder (L/D=42) of d 30 mm, and were melt-kneaded under a temperature of 120° C. at a screw rotation frequency of 180 rpm and a supply speed of 16 Kg/hour to obtain a thermosetting resin composition. The composition was again melt-kneaded with the extruder, and then the thermosetting resin composition was extrusion-molded on a side of a polyethylene terephthalate film (X-31, manufactured by Teijin Dupont Film Co., Ltd.) on which a silicon releasing agent had been coated, to obtain a bi-layered adhesive film composed of a layer having a thickness of about 15 μm which dad been obtained from the thermosetting resin composition and the polyethylene terephthalate film layer (support substrate layer).

(2) <Production Example of Laminate>

A printed circuit board (both sides copper-clad laminate plate; R-1705, manufactured by Matsushita Electric Works, Ltd.) as an adherend was laminated on the layer obtained from the thermosetting resin composition, of the bi-layered adhesive film obtained in the above item (1). The resulting board was thermally pressed under the conditions of 100° C., 3 MPa for 10 minutes from an upper side of the support substrate, and was thermally cured under the conditions for 180° C., 3 MPa for 60 minutes to obtain a laminate. Subsequently, the resulting laminate was allowed to stand for 1 hour at a temperature of 23° C. and a humidity of 50%. Thereafter, the laminate was cut into a piece of 10 mm width×100 mm length, and a peeling test was performed at a peeling rate of 100 mm/sec and a peeling angle of 1800 while holding the support substrate at a temperature of 23° C. and a humidity of 50%. The polyethylene terephthalate film layer (as a support substrate) was peeled off at a peeling strength of 0.01 N/cm or less but the layer obtained from the adhesive film was not peeled.

As mentioned above, the thermosetting resin composition of the present invention can directly provide an adhesive film from the thermosetting resin composition by extrusion molding without steps of dissolution in an organic solvent, coating and drying. The laminate which is obtained by bonding the adhesive film on an adherent is excellent in solder heat resistance and adhesive property.

By utilizing such excellent properties, the laminate of the present invention can be used as, for example, semiconductor encapsulating materials, electronic part encapsulating materials such as solar cells and EL (electroluminescence) lamps, die bonding sheets between integrated circuit and substrate, and interlayer insulating layers between substrates. Further, the adhesive film can be provided for a solder resist which protects a substrate from a solder, and a protective sheet at a production step of electronic parts.

1. A thermosetting resin composition comprising component (A) and component (B) below, wherein the sum of the content of the component (A) and component (B) is 90% by weight or more based on the composition;
component (A): at least one selected from amino acids and imidazoles, and
component (B): an epoxy group-containing ethylene copolymer obtained by polymerizing monomer (b₁) and monomer (b₂) below:
monomer (b₁): at least one selected from ethylene and propylene, and
monomer (b₂): a monomer represented by formula (1) below: 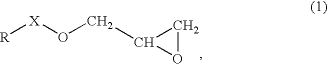
(wherein R represents a hydrocarbon group of a carbon number of from 2 to 18 having a double bond, at least one of hydrogen atoms of the hydrocarbon group may be substituted with a halogen atom, a hydroxyl group or a carboxyl group, and X represents a single bond or a carbonyl group.)

2. The thermosetting resin composition according to claim 1, wherein the content of a structural unit derived from monomer (b₂) is 1 to 30 parts by weight relative to 100 parts by weight of component (B).

3. The thermosetting resin composition according to claim 1, wherein the content of a structural unit derived from monomer (b₁) is 30 to 75 parts by weight relative to 100 parts by weight of component (B).

4. The thermosetting resin composition according to claim 1, wherein component (B) is a copolymer obtained by polymerizing monomer (b₁), monomer (b₂) and monomer (b₃) below:
monomer (b₃): a monomer which has a functional group copolymerizable with ethylene, does not have a functional group reactive with an epoxy group, and is different from either of monomer (b₁) and monomer (b₂)

5. The thermosetting resin composition according to claim 1, wherein the ratio by weight of component (A) and component (B) ((A)/(B)) is from 0.1/99.9 to 10/90.

6. The thermosetting resin composition according to claim 1, which further contains component (C) below:
component (C): an antioxidant.

7. The thermosetting resin composition according to claim 6, wherein component (C) is at least one selected from the group consisting of a phenolic antioxidant, a phosphoric antioxidant and a sulfuric antioxidant.

8. The thermosetting resin composition according to claim 1, wherein component (A) is an amino acid, and the amino acid is at least one selected from aminoacetic acid, β-alanine, 4-aminobutyric acid, aminovalerianic acid, 6-aminohexanoic acid, 11-aminoundecanoic acid and 12-aminododecanoic acid.

9. The thermosetting resin composition according to claim 1, wherein component (A) is an imidazole, and the imidazole is at least one selected from 1-cyanoethyl-2-ethyl-4-methylimidazolium trimellitate, 1-cyanoethyl-2-undecylimidazolium trimellitate, 1-cyanoethyl-2-phenylimidazolium trimellitate, 2,4-diamino-6-[2′-methylimidazolyl-(1′)]-ethyl-s-triazine, 2,4-diamino-6-(2′-undecylimidazolyl)-ethyl-s-triazine, 2,4-diamino-6-[2′-ethyl-4-methylimidazolyl-(1′)]-ethyl-s-triazine, an adduct of 2,4-diamino-6-[2′-methylimidazolyl-(1′)]-ethyl-s-triazine with isocyanuric acid, an adduct of 2-phenylimidazole with isocyanuric acid, and an adduct of 2-methylimidazole with isocyanuric acid.

10. An adhesive film comprising the thermosetting resin composition according to claim 1.

11. The adhesive film according to claim 10, which is obtained by extrusion-molding the thermosetting resin composition according to claim 1.

12. An adhesive film, which is obtainable by further irradiating an electron beam on the adhesive film according to claim 10.

13. The adhesive film according to claim 12, which is obtainable by performing the electron beam irradiation plural times.

14. A laminate, which is obtainable by laminating the adhesive film according to claim 10 or 12 with an adherent, and thermally curing the resultant.
